(19) United States
(12) Patent Application Publication
(10) Pub. No.: US 2026/0121334 A1
(43) Pub. Date: Apr. 30, 2026

(54) ELECTRICAL CONNECTOR WITH WIRE PORT SKIRT

(71) Applicant: IDEAL Industries, Inc., Sycamore, IL (US)

(72) Inventors: Douglas A. Sanford, Littleton, CO (US); Jason W. Ludewig, Rockford, IL (US); Alan Emad Zantout, Sycamore, IL (US)

(21) Appl. No.: 19/371,883

(22) Filed: Oct. 28, 2025

Related U.S. Application Data
(60) Provisional application No. 63/713,015, filed on Oct. 28, 2024.

(51) Int. Cl. H01R 13/506; H01R 13/424; H01R 13/44; H01R 13/627

(52) U.S. Cl. CPC H01R 13/506; H01R 13/424; H01R 13/44; H01R 13/6271

(57) ABSTRACT

An electrical connector includes a plurality of clamping connections, a housing defining a plurality of conductor insertion ports, each leading to a respective one of the clamping connections, and an electrically-insulative skirt coupled to the housing, the skirt defining one or more apertures that extend from the conductor insertion ports along a conductor insertion direction.

### CROSS-REFERENCE TO RELATED APPLICATION

This application claims the benefit of priority to U.S. provisional application no. 63/713,015, filed Oct. 28, 2024, which is hereby incorporated by reference in its entirety.

### FIELD OF THE DISCLOSURE

The present disclosure relates generally to electrical connectors, including lever connectors and push-in connectors.

### BACKGROUND

When inserting electrical conductors into connector terminals, such as push-in connectors and lever connectors, an electrician or other installer generally strips the conductor to expose a desired length of bare wire to be inserted into the connector.

### BRIEF DESCRIPTION OF THE DRAWINGS

FIG. 1A is a perspective view of an electrical connector with a skirt.

FIG. 1B is a side cross-sectional view of the electrical connector of FIG. 1A.

FIG. 1C is a front perspective exploded view of the electrical connector of FIG. 1A.

FIG. 1D is a rear perspective exploded view of the electrical connector of FIG. 1A.

FIG. 2A is a perspective view of an electrical connector with a skirt.

FIG. 2B is a perspective view of the electrical connector of FIG. 2A.

FIG. 2C is a front perspective exploded view of the electrical connector of FIG. 2A.

FIG. 2D is a rear perspective exploded view of the electrical connector of FIG. 2A.

FIG. 3A is a perspective view of an electrical connector with a skirt.

FIG. 3B is a perspective view of the electrical connector of FIG. 3A.

FIG. 3C is a front perspective exploded view of the electrical connector of FIG. 3A.

FIG. 3D is a rear perspective exploded view of the electrical connector of FIG. 3A.

FIG. 4A is a perspective view of an electrical connector with a skirt.

FIG. 4B is a perspective view of the electrical connector of FIG. 4A.

FIG. 4C is a front perspective exploded view of the electrical connector of FIG. 4A.

FIG. 4D is a perspective cross-sectional view of the electrical connector of FIG. 4A.

FIG. 4E is a side cross-sectional view of the electrical connector of FIG. 4A.

FIG. 5A is a perspective view of an electrical connector with a skirt.

FIG. 5B is a perspective view of the electrical connector of FIG. 5A.

FIG. 5C is a front perspective exploded view of the electrical connector of FIG. 5A.

FIG. 6A is a perspective view of an electrical connector with a skirt.

FIG. 6B is a front perspective exploded view of the electrical connector of FIG. 6A.

FIG. 6C is a rear perspective exploded view of the electrical connector of FIG. 6A.

### DETAILED DESCRIPTION

When installing electrical conductors in a connector terminal, the electrician may err on the side of overstripping, rather than understripping, the wire in order to ensure clean contact between the conductor and the terminal. An overstripped wire, however, may result in exposed conductor outside of the terminal, which may contact environmental bodies that are electrically-conductive, causing a hazard. Accordingly, a flexible and/or rigid “skirt” which extends from the wire entry side of a multi-port connector could provide great piece of mind from an installer's perspective by providing a larger tolerance for the installers conductor strip length, and may also provide increased dielectric protection. The present disclosure includes protrusions, “skirts”, which either extend circumferentially around each individual port or around the periphery of all ports on the connector on the conductor entry side, or a combination thereof (e.g., individual ports with individual skirts and a skirt extending around multiple ports on the same connector). These skirts could be directly adhered through a two-shot molding process or other process or mechanically added either during initial manufacturing or provided/offered as an accessory device that can be removably added to the connector.

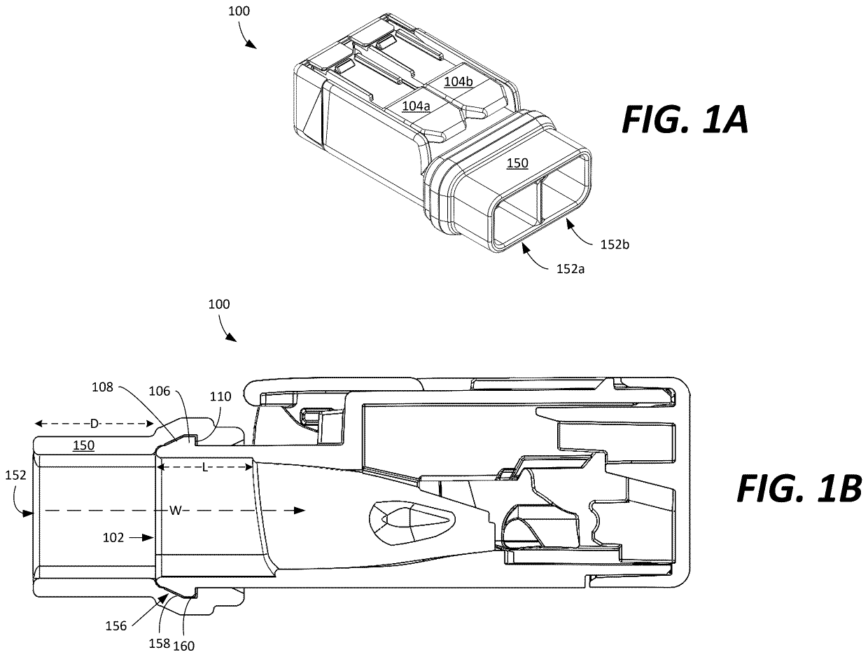

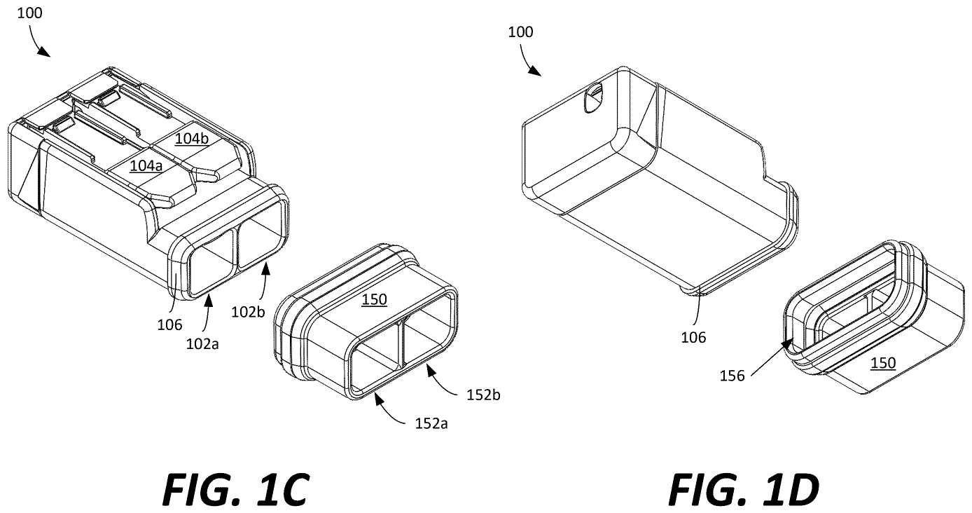

FIGS. 1A-1D illustrate a lever connector 100 with a skirt 150. The lever connector 100 may be substantially similar to or may include features from the lever connectors described in U.S. Pat. No. 11,695,224, which is hereby incorporated by reference in its entirety, and may additionally include the skirt 150 and one or more structures on the connector 100 for coupling with the skirt 150.

The connector 100 may include a housing defining two wire entry ports 102a, 102b, each leading to a respective clamping connection which may be opened and closed by user actuation of a respective lever 104a, 104b. Wires may be inserted along a wire insertion direction W (annotated in FIG. 1B). References to “forward”, “rearward”, and “circumferential” herein are with respect to the wire insertion direction W. “Forward” refers to opposite the direction in which a conductor is inserted (towards the left in the view of FIG. 1B), and “rearward” refers to the direction in which a conductor is inserted (towards the right in the view of FIG. 1B).

The skirt 150 may be coupled to the front of the connector 100, i.e., the conductor entry side of the connector 100. The skirt 150 may include two wire entry ports 152a, 152b that, when the skirt is coupled to the connector 100, align with the wire entry ports 102a, 102b, respectively, of the connector 100. The wire entry ports 152a, 152b of the skirt 150 may have substantially the same width and height as the wire entry ports 102a, 102b (e.g., the width and height at the front opening of the port 102a, 102b) of the connector 100.

The skirt 150, and all skirts of this disclosure, may be made from or may comprise a flexible, electrically-insulative material. For example, the skirt 150 may be made from or may comprise thermoplastic elastomer (TPE), such as thermoplastic polyurethane (TPU), and/or another appropriate material.

The skirt 150 may extend around an entire lateral circumference of the connector 100, as shown in FIGS. 1A-1D, in some embodiments. Alternatively, in some embodiments, the skirt 150 may include circumferential discontinuities or gaps.

The connector 100 and skirt 150 may include complementary mechanical features for coupling and securing the skirt 150 to the connector 100. In an embodiment, the connector 100 may include a circumferential protrusion 106 extending around some or all of the outer surface of the connector. As best shown in FIG. 1B, the protrusion 106 may include a chamfer or ramped surface 108 and a vertical, outwardly-extending (e.g., extending away from the ports 102a, 102b) stop surface 110 rearward of the ramped surface 108. The protrusion may be just rearward of the wire entry ports 102a, 102b, and forward of the levers 104a, 104b.

The skirt 150 may include a circumferential receiving space 156 (e.g., recess) for the protrusion 106. The receiving space 156 may include an inner ramped surface 158 and a vertical stop surface 160 that correspond with the ramped surface 108 and a vertical, inwardly-extending stop surface 110 of the connector 100, respectively. In operation, when the skirt 150 is flexible, a user may move the rearward edge of the skirt 150 over the forward edge of the connector 100. As the skirt 150 is moved, the skirt rearward edge may flex over the chamfer 108 until the vertical surface 160 is rearward of the vertical surface 110. Contact of the vertical surface 110 with the vertical surface 160 may prevent accidental forward movement of the skirt 150 once it is coupled to the connector 100. A user may remove the skirt 150 by flexing the rearward edge of the skirt 150 outward to clear the vertical surface 160 over the vertical surface 110.

In some embodiments, the skirt 150 (like all skirts of this disclosure) may be molded directly on the connector 100. In such overmold embodiments, the skirt may be rigid or flexible, and may be removable or not removable. In other embodiments, the skirt 150 (like all skirts of this disclosure) may be formed independent of the connector 100 and manually coupled to the connector during an assembly step.

The skirt 150 may extend further forward than the body of the connector 100 by a depth D (annotated in FIG. 1B). The depth D may be at least the same depth as, or a greater depth than, a lead-in portion L (also annotated in FIG. 1B) of the connector ports 104a, 104b. The lead-in portion may be defined by an inner wall of the port 104a, 104b formed by the housing of the connector 100. Additionally or alternatively, the depth D may be equal to or greater than a diameter of a port 102a, 102b.

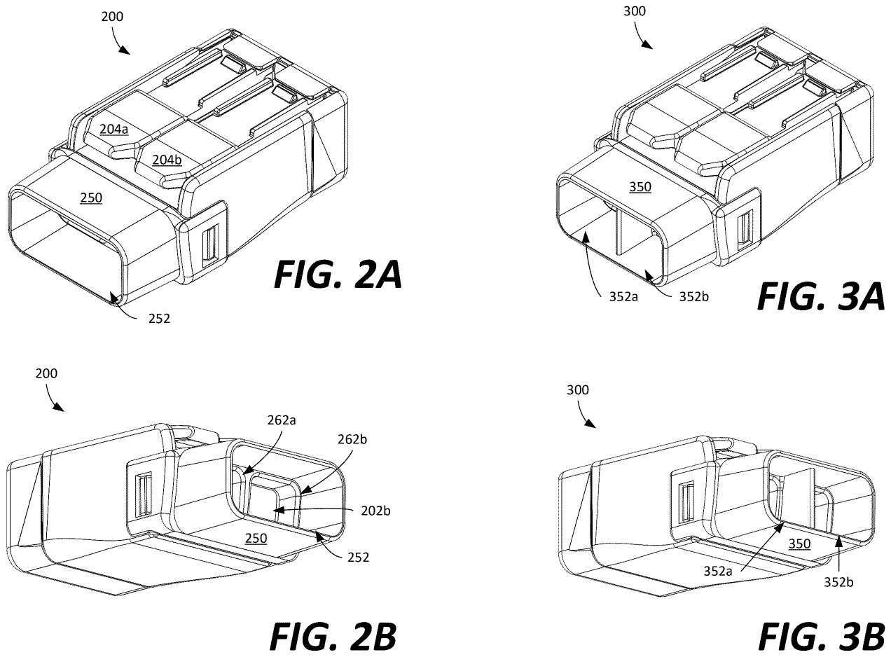

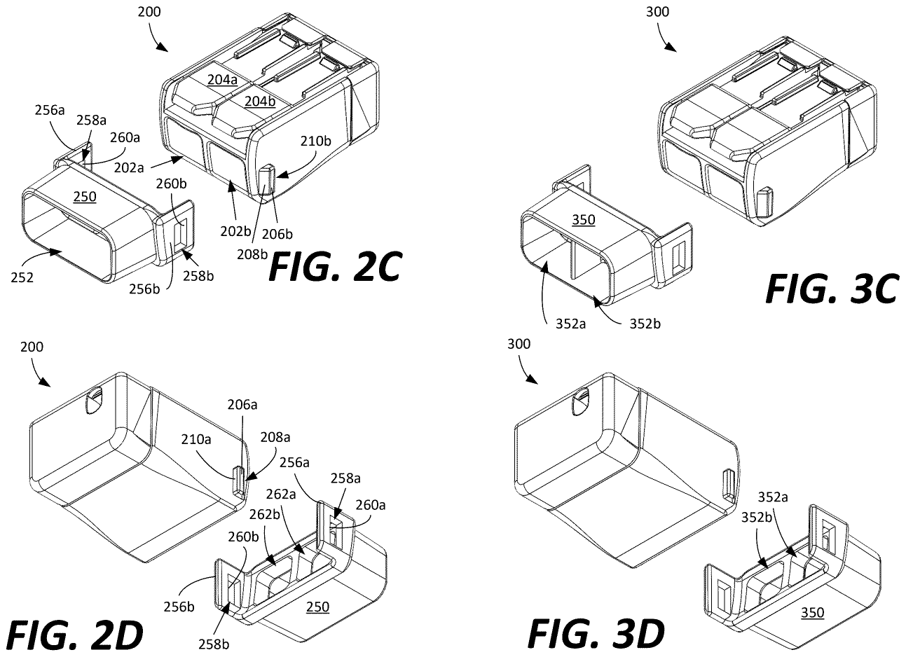

FIGS. 2A-2D illustrate a lever connector 200 with a skirt 250. The lever connector 200 may be substantially similar to or may include features from the lever connectors described in U.S. Pat. No. 11,695,224, and may additionally include the skirt 250 and one or more structures on the connector 200 for coupling with the skirt 250.

The connector 200 may include a housing defining two wire entry ports 202a, 202b, each leading to a respective clamping connection which may be opened and closed by user actuation of a respective lever 204a, 204b.

The skirt 250 may be coupled to the front of the connector 200, i.e., the conductor entry side of the connector 200. The skirt 250 may include a single aperture 252 that, when the skirt is coupled to the connector 100, provides access to both wire entry ports 202a, 202b. The aperture 252 of the skirt 150 may have substantially the same height as the wire entry ports 202a, 202b (e.g., the width and height at the front opening of the port 202a, 202b) of the connector 100. The aperture 252 of the skirt 250 may have a width that extends from the outer edge of one port 202a to the outer edge of the other port 202b.

The skirt 250 may also include, at the rearward end of the aperture 252, separate wire entry ports 262a, 262b that align with the wire entry ports 202a, 202b, respectively. The entry ports 262a, 262b may have substantially the same width and height as the wire entry ports 202a, 202b.

The connector 200 and skirt 250 may include complementary mechanical features (labeled in FIGS. 2C, 2D) for coupling the skirt 250 to the connector 200. In an embodiment, the skirt 250 may include lateral extension members 256a, 256b that extend rearward over the lateral sides of the connector 200. Each extension member 256a, 256b may define an aperture 258a, 258b or recess and one or more vertical stop surfaces 260a, 260b.

The connector 200 may include, on each lateral side, a lateral protrusion 206a, 206b positioned to interface with the aperture 258a, 258b on the corresponding extension member 256a, 256b. Each lateral protrusion 206a, 206b may include a ramped surface 208a, 208b and a vertical stop surface 210a, 210b. In operation, where the skirt 250 is flexible, a user may move the rearward edge of the skirt 250 over the forward edge of the connector 200. As the skirt 250 is moved, the respective rearward edge of each extension member 256a, 256b may flex over the ramped surface 208a, 208b until the vertical surface aperture 258a, 258b is over the protrusion 206a, 206b. Contact of the vertical surface 210a, 210b with the vertical surface 260a, 260b may prevent accidental forward movement of the skirt 250 once it is coupled to the connector 200. A user may remove the skirt 250 by flexing the rearward edges of the extension member 256a, 256b outward to clear the vertical surface 260a, 260b over the vertical surface 210a, 210b. Alternatively, as discussed above, the skirt 250 may be molded directly on the connector 200.

FIGS. 3A-3D illustrate a lever connector 300 with a skirt 350. The connector 300 may be identical to the connector 200. The skirt 350 may be identical to the skirt 250, except the skirt 350 may include separate wire entry ports 352a, 352b having the same features as the wire entry ports 152a, 152b of the skirt 150 of FIGS. 1A-1D.

Although the connectors 100, 200, 300 include two ports for two conductors, it should be understood that the skirts 150, 250, 350 may be used with connectors having any number of ports (e.g., two ports, three ports, four ports, etc.). Such skirts may include a single aperture for all ports (as in skirt 250) or full-depth separate ports for each conductor (as in skirts 150, 350).

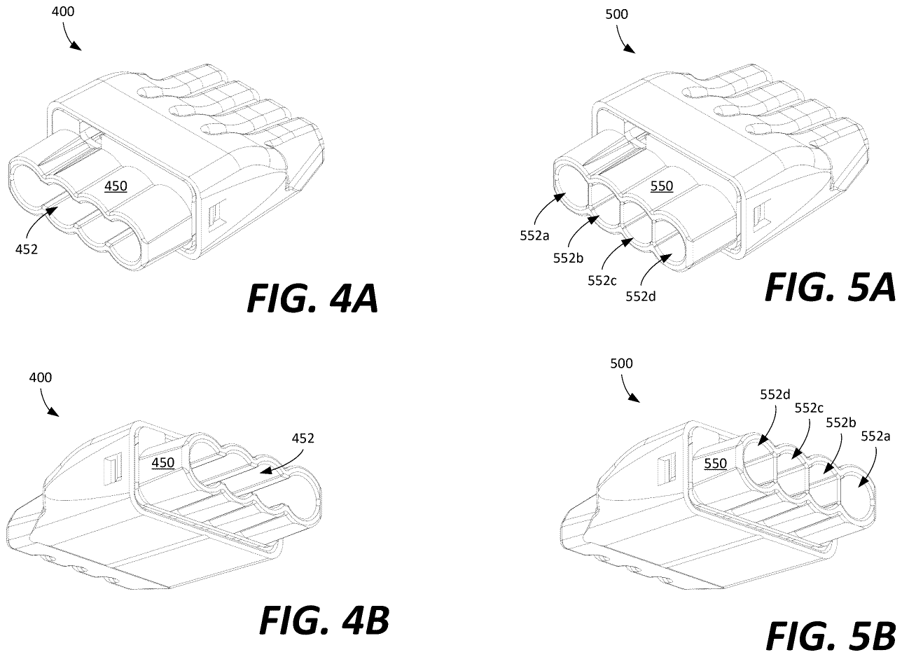

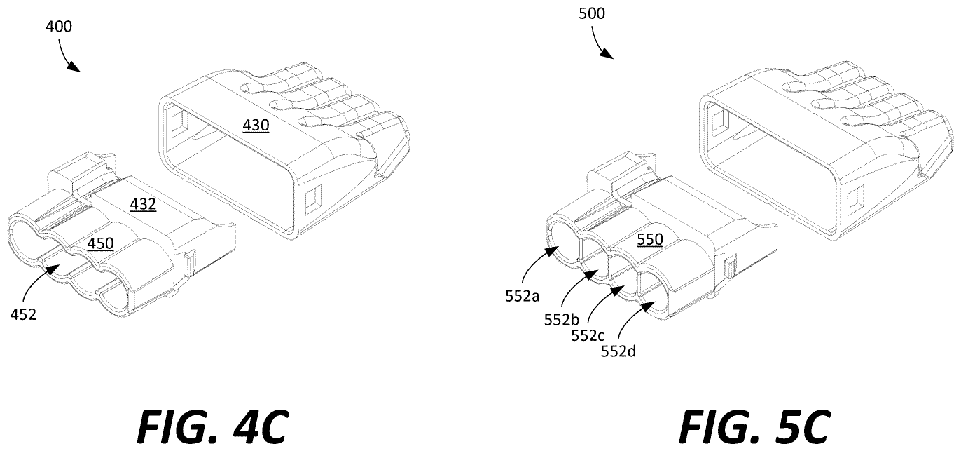

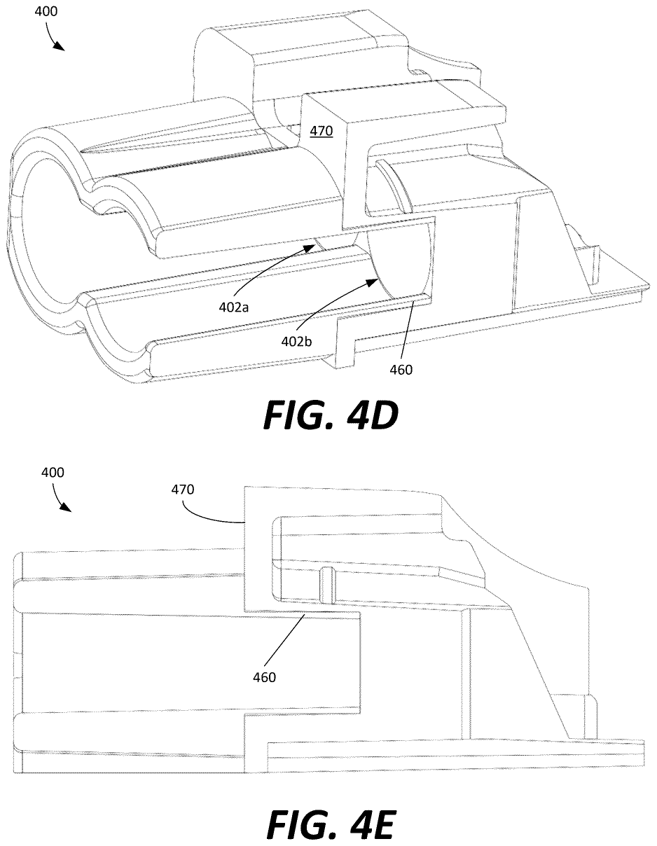

FIGS. 4A-4E illustrate a push-in connector 400 with a skirt 450. The push-in connector 400 may be substantially similar to or may include features from the push-in connectors described in U.S. Pat. No. 7,507,106, which is hereby incorporated by reference in its entirety, and may additionally include the skirt 450 and one or more structures on the connector 400 for coupling with the skirt 450.

The connector 400 may include four wire entry ports (two such ports 402a, 402b are designated in FIG. 4D), each leading to a respective clamping connection which may be opened and closed by the force of a user pushing in a conductor. Although four ports 402 are included on connector 400, the connector 400 could have any number of ports. The connector 400 may be multi-pole or single-pole.

The skirt 450 may be coupled to the front of the connector 400, i.e., the conductor entry side of the connector 400. The skirt 450 may include a single aperture 452 that, when the skirt 450 is coupled to the connector 400, provides access to all wire entry ports 402a, 402b, 402c, 402d. The aperture 452 of the skirt 450 may have substantially the same height as the wire entry ports 402a, 402b, 402c, 402d (e.g., the width and height at the front opening of the port 402a, 402b, 402c, 402d) of the connector 400. The height of the aperture 452 may vary across its width, such that the aperture is contoured to indicate where the wire entry ports 402a, 402b, 402c, 402d are located. The aperture 452 of the skirt 450 may have a width that extends from the outer edge of one end port 402a to the outer edge of the other end port 402d.

The skirt 450 may be in the form of an overmold on the front side of the connector 400. In some embodiments, the skirt 450 may include a longitudinal extension surface 460 that longitudinally overlaps with the body of the connector 400. For example, the longitudinal extension surface 460 may extend into the body of the connector 400, inward of the planar face 470 of the connector 400. Alternatively, the body of the connector 400 may include a longitudinal extension surface extending outward beyond the planar face 470. In either case, such a longitudinal extension surface may provide additional surface coupling between an overmolded skirt 450 and connector 400. Alternatively, in some embodiments, the skirt 450 may be overmolded on the connector 400 such that the only contact is between the planar face 470 of the connector and the adjacent face of the skirt 450. Still further, in some embodiments, the skirt 450 may be made flexible and removable from the connector 400, and the longitudinal extension surface 460 of the skirt 450 or connector 400 may include mechanical features shown herein (e.g., one or more protrusions, recesses, etc.) that may mate with corresponding features on the other of the skirt 450 or connector 400.

As shown in FIG. 4C, the connector 400 may include a first housing portion 430 and a second housing portion 432. The first housing portion 430 may define an outer shell, and the second housing portion 432 may snap or otherwise couple to the interior of the first housing portion 430. The second housing portion 432 may define the wire entry ports 402a, 402b, 402c, 402d.

FIGS. 5A-5C illustrate a push-in connector 500 with a skirt 550. The connector 500 may be identical to the connector 400. The skirt 550 may be identical to the skirt 450, except the skirt 550 may include separate wire entry ports 552a, 552b, 552c, 552d that, when the skirt 550 is coupled to the connector 100, align with the wire entry ports 502a, 502b, 502c, 502d respectively, of the connector 500. The wire entry ports 552a, 552b, 552c, 552d of the skirt 550 may have substantially the same width and height as the wire entry ports 502a, 502b, 502c, 502d (e.g., the width and height at the front opening of the port 502a, 502b, 502c, 502d) of the connector 500.

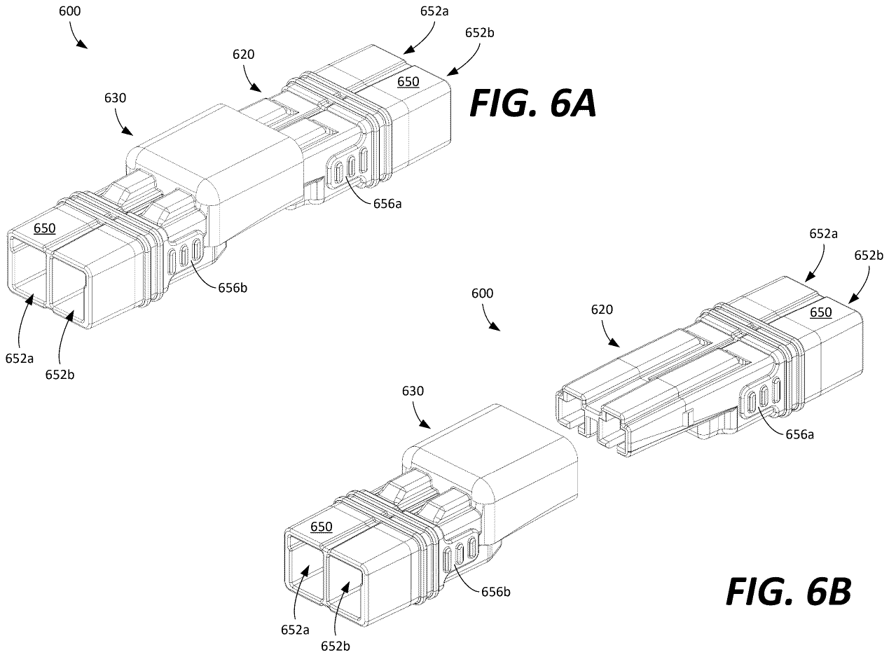

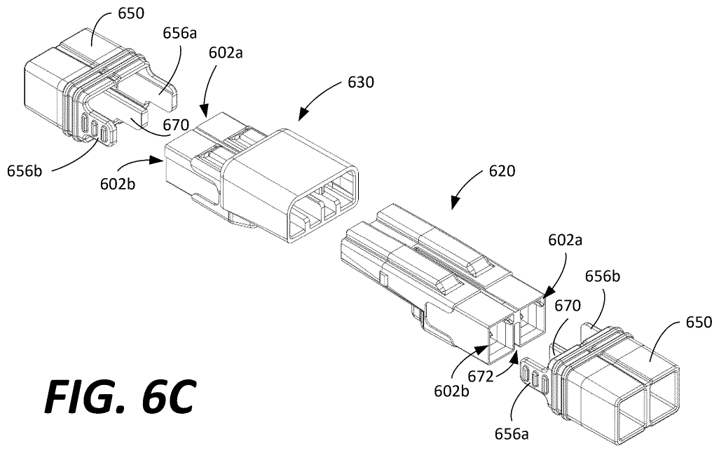

FIGS. 6A-6C illustrate a push-in connector disconnect 600 having a plug connector 620 and a receptacle connector 622, each with a skirt 650. The plug connector 620 may be inserted into the receptacle connector 622 (e.g., at a respective end of each opposite the conductor insertion side) to connect the conductors in the plug 620 to the wires in the receptacle 622. The disconnect 600 may be substantially similar to or may include features from the disconnects described in U.S. Pat. No. 7,527,509, which is hereby incorporated by reference in its entirety, and may additionally include the skirts 650. Each skirt 650 may be in the form of an overmold on the front side of the connector 620, 622. The connector 600 may be multi-pole or single-pole.

Each connector 620, 622 may include two wire entry ports 602a, 602b, each leading to a respective clamping connection which may be opened and closed by the force of a user pushing in a conductor.

Each skirt 650 may be coupled to the front of the connector 620, 622, i.e., the conductor entry side of the connector 620, 622. The skirt 650 may include two wire entry ports 652a, 652b that, when the skirt is coupled to a connector 620, 622, align with the wire entry ports 602a, 602b, respectively, of the connector 620, 622. The wire entry ports 652a, 652b of the skirt 650 may have substantially the same width and height as the wire entry ports 602a, 602b (e.g., the width and height at the front opening of the port 602a, 602b) of the connector 620, 622.

Each skirt 650 may include two lateral extension members 656a, 656b that extend rearward over the lateral sides of the connector 620, 630 and a central extension member 670 that mates with a central recess 672 defined in each connector body 620, 630. Each central recess 672 may be defined between wire entry ports 652a, 652b.

In a first aspect of the present disclosure, an electrical connector is provided that includes a plurality of clamping connections, a housing defining a plurality of conductor insertion ports, each leading to a respective one of the clamping connections, and an electrically-insulative skirt coupled to the housing, the skirt defining one or more apertures that extend from the conductor insertion ports along a conductor insertion direction.

In an embodiment of the first aspect, the skirt is overmolded on the housing.

In an embodiment of the first aspect, the skirt is removably coupled to the housing.

In an embodiment of the first aspect, the skirt has a longitudinal depth that is the same as or larger than a diameter of one of the conductor insertion ports.

In an embodiment of the first aspect, the skirt defines a plurality of apertures, the plurality of apertures comprising a respective aperture for each conductor insertion port of the plurality of conductor insertion ports.

In an embodiment of the first aspect, the skirt defines a single aperture that extends from the plurality of conductor insertion ports.

In an embodiment of the first aspect, the housing includes a circumferential outwardly-extending protrusion on an outer surface of the housing, and the skirt defines a circumferential recess in an inner surface of the skirt for mating with the protrusion to secure the skirt to the housing.

In an embodiment of the first aspect, the skirt includes one or more extension members that extend rearward over one or more lateral sides of the connector housing, wherein each extension member comprises one of: (a) a recess or aperture, or (b) a protrusion, and each of the one or more lateral sides the connector housing comprises the other of: (a) a recess or aperture, or (b) a protrusion, for mating with the recess, aperture, or protrusion of the corresponding extension member to secure the skirt to the connector housing.

In an embodiment of the first aspect, the connector housing defines a recess between two of the plurality of conductor insertion ports, and the skirt comprises a longitudinal extension member that extends into the recess to secure the skirt to the connector housing.

In an embodiment of the first aspect, the electrical connector is a lever connector.

In an embodiment of the first aspect, the electrical connector is a push-in connector.

In an embodiment of the first aspect, the skirt extends around an entire lateral circumference of the connector housing.

In a second aspect of the present disclosure, an electrical connector is provided that includes a plurality of clamping connections, a housing defining a plurality of conductor insertion ports, each leading to a respective one of the clamping connections, and an electrically-insulative skirt coupled to the housing, the skirt defining one or more apertures that extend from the conductor insertion ports along a conductor insertion direction, wherein the housing includes a circumferential outwardly-extending protrusion on an outer surface of the housing, and the skirt defines a circumferential recess in an inner surface of the skirt for mating with the protrusion to secure the skirt to the housing, or the skirt comprises one or more extension members that extend rearward over one or more lateral sides of the connector housing, wherein each extension member comprises one of: (a) a recess or aperture, or (b) a protrusion, and each of the one or more lateral sides the connector housing comprises the other of: (a) a recess or aperture, or (b) a protrusion, for mating with the recess, aperture, or protrusion of the corresponding extension member to secure the skirt to the connector housing.

In an embodiment of the second aspect, the skirt has a longitudinal depth that is the same as or larger than a diameter of one of the conductor insertion ports.

In an embodiment of the second aspect, the skirt defines a plurality of apertures, the plurality of apertures including a respective aperture for each conductor insertion port of the plurality of conductor insertion ports.

In an embodiment of the second aspect, the skirt defines a single aperture that extends from the plurality of conductor insertion ports.

In an embodiment of the second aspect, the skirt extends around an entire lateral circumference of the connector housing.

In a third aspect of the present disclosure, an electrical connector is provided that includes a plurality of clamping connections, a housing defining a plurality of conductor insertion ports, each leading to a respective one of the clamping connections, and an electrically-insulative skirt coupled to the housing, the skirt defining one or more apertures that extend from the conductor insertion ports along a conductor insertion direction, wherein the skirt is overmolded on the housing.

In an embodiment of the third aspect, the skirt has a longitudinal depth that is the same as or larger than a diameter of one of the conductor insertion ports.

In an embodiment of the third aspect, the skirt extends around an entire lateral circumference of the connector housing.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known components have not been described in detail as not to unnecessarily obscure various aspects of the present disclosure.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. An electrical connector comprising:
a plurality of clamping connections;
a housing defining a plurality of conductor insertion ports, each leading to a respective one of the clamping connections; and
an electrically-insulative skirt coupled to the housing, the skirt defining one or more apertures that extend from the conductor insertion ports along a conductor insertion direction.

2. The electrical connector of claim 1, wherein the skirt is overmolded on the housing.

3. The electrical connector of claim 1, wherein the skirt is removably coupled to the housing.

4. The electrical connector of claim 1, wherein the skirt has a longitudinal depth that is the same as or larger than a diameter of one of the conductor insertion ports.

5. The electrical connector of claim 1, wherein the skirt defines a plurality of apertures, the plurality of apertures comprising a respective aperture for each conductor insertion port of the plurality of conductor insertion ports.

6. The electrical connector of claim 1, wherein the skirt defines a single aperture that extends from the plurality of conductor insertion ports.

7. The electrical connector of claim 1, wherein:
the housing includes a circumferential outwardly-extending protrusion on an outer surface of the housing; and the skirt defines a circumferential recess in an inner surface of the skirt for mating with the protrusion to secure the skirt to the housing.

8. The electrical connector of claim 1, wherein:
the skirt comprises one or more extension members that extend rearward over one or more lateral sides of the connector housing, wherein each extension member comprises one of: (a) a receiving formation, the receiving formation comprising a recess or aperture, or (b) a protrusion; and
each of the one or more lateral sides the connector housing comprises the other of: (a) a receiving formation, the receiving formation including a recess or aperture, or (b) a protrusion;
wherein the receiving formation or protrusion of each extension member mates with a corresponding receiving formation or protrusion of the connector housing to secure the skirt to the connector housing.

9. The electrical connector of claim 1, wherein:
the connector housing defines a recess between two of the plurality of conductor insertion ports; and
the skirt comprises a longitudinal extension member that extends into the recess to secure the skirt to the connector housing.

10. The electrical connector of claim 1, wherein the electrical connector is a lever connector.

11. The electrical connector of claim 1, wherein the electrical connector is a push-in connector.

12. The electrical connector of claim 1, wherein the skirt extends around an entire lateral circumference of the connector housing.

13. An electrical connector comprising:
a plurality of clamping connections;
a housing defining a plurality of conductor insertion ports, each leading to a respective one of the clamping connections; and
an electrically-insulative skirt coupled to the housing, the skirt defining one or more apertures that extend from the conductor insertion ports along a conductor insertion direction;
wherein:
the housing includes a circumferential outwardly-extending protrusion on an outer surface of the housing; and
the skirt defines a circumferential recess in an inner surface of the skirt for mating with the protrusion to secure the skirt to the housing; or
the skirt comprises one or more extension members that extend rearward over one or more lateral sides of the connector housing, wherein each extension member comprises one of: (a) a receiving formation, the receiving formation comprising a recess or aperture, or (b) a protrusion; and
each of the one or more lateral sides the connector housing comprises the other of:
(a) a receiving formation, the receiving formation including a recess or aperture, or (b) a protrusion, wherein the receiving formation or protrusion of each extension member mates with a corresponding receiving formation or protrusion of the connector housing to secure the skirt to the connector housing.

14. The electrical connector of claim 13, wherein the skirt has a longitudinal depth that is the same as or larger than a diameter of one of the conductor insertion ports.

15. The electrical connector of claim 13, wherein the skirt defines a plurality of apertures, the plurality of apertures comprising a respective aperture for each conductor insertion port of the plurality of conductor insertion ports.

16. The electrical connector of claim 13, wherein the skirt defines a single aperture that extends from the plurality of conductor insertion ports.

17. The electrical connector of claim 13, wherein the skirt extends around an entire lateral circumference of the connector housing.

18. An electrical connector comprising:
a plurality of clamping connections;
a housing defining a plurality of conductor insertion ports, each leading to a respective one of the clamping connections; and
an electrically-insulative skirt coupled to the housing, the skirt defining one or more apertures that extend from the conductor insertion ports along a conductor insertion direction;
wherein the skirt is overmolded on the housing.

19. The electrical connector of claim 18, wherein the skirt has a longitudinal depth that is the same as or larger than a diameter of one of the conductor insertion ports.

20. The electrical connector of claim 18, wherein the skirt extends around an entire lateral circumference of the connector housing.
